(19) United States
(12) Patent Application Publication
(10) Pub. No.: US 2009/0106226 A1
(43) Pub. Date: Apr. 23, 2009

(54) SEARCH SHORTCUT PULLQUOTES

(76) Inventors: Erik Ojakaar, San Jose, CA (US); Christopher Tung, Pacifica, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/875,666

(22) Filed: Oct. 19, 2007

(51) Int. Cl. G06F 17/30

(52) U.S. Cl. 707/5; 707/3; 707/E17.075

(57) ABSTRACT

A system for assisting users in obtaining objective information about consumer products is provided. The system includes pullquotes within a listing of ordered search results, where the pullquotes are extracted from independent objective consumer reviews.

### FIELD OF THE INVENTION

The present invention relates to a system for assisting users in obtaining objective information about consumer products.

### BACKGROUND

When a user performs a search of a computer network resource, such as but not limited to the Internet, a provider associated with that network may post a specialized means of obtaining further information within the search results. One type of such specialized information is known as a shortcut. Shortcuts (also known as direct displays) are sometimes used within the search results of content providers. Shortcuts can direct a user to content within a content provider's Travel, Autos, or Shopping sections, among others. However, the click through rate on these shortcuts is generally low for a variety of reasons.

One reason for the low click-through rate of shortcuts is discoverability. Search results sometimes contain visual clutter, so that a shortcut may get buried and go unused. Another, related reason for the low click-through rate of shortcuts is a lack of certainty of whether the shortcut will truly lead to the desired content.

When users are researching consumer products (e.g. digital camera, barbeque grill, cellphone, automobile, restaurant, movie, movie theater, etc.) using a computer network such as the Internet, those users generally begin the process using some type of search engine. These users often seek independent reviews of those products to guide their decisions.

Some mechanisms for formatting search results are focused on comparing prices and finding bargains. However, these mechanisms do not address a more prevalent product research need, which is to read user reviews. Consequently, a mechanism for providing user reviews to be easily accessible within the results of a consumer search process is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example system for managing pullquotes, according to an embodiment of the invention;

FIG. 2 shows an example pullquote within the system of FIG. 1; and

FIG. 3 shows a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Systems are described herein which incorporate pullquotes (excerpts from consumer reviews of products or services) within the results of searches that are performed by users. The pullquotes contain objective non-advertising information that can assist users in making a purchasing decision. Thus, the pullquotes make the search results more salient, useful, and relevant to a user. Having the pullquote conveniently located within the search results reduces the amount of work and effort for a user to obtain valid results, and reduces the time necessary to bring a consumer to a buying decision.

### Explanation of System

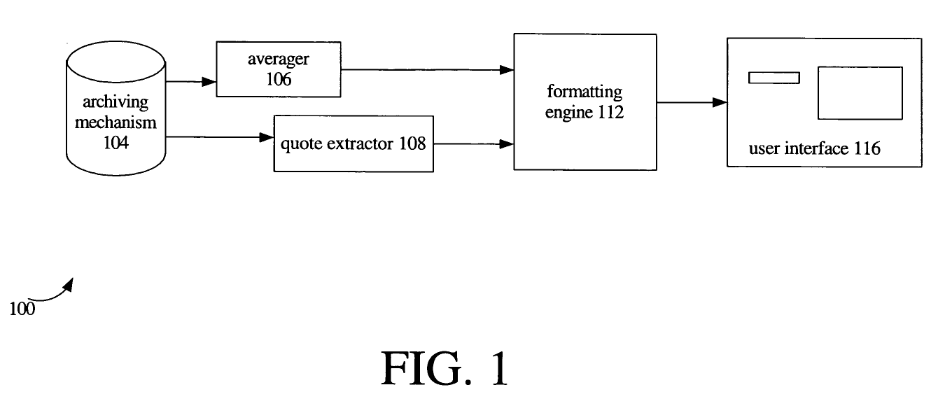

FIG. 1 shows an example system 100 for managing consumer reviews, transforming consumer reviews into pullquotes, and including the pullquotes within search results. The system 100 contains an archiving mechanism 104 for storing consumer reviews of various products, services, and consumer items. The system 100 includes an averager 106 for computing and storing ratings based on a five-star consumer rating scale, and correlating those rating to a specific consumer review.

The system 100 also includes a pullquote extractor 108 which works with the archiving mechanism 104 to obtain and forward suitable pullquotes for inclusion within search results. The formatting engine 112 ensures a particular quote is suitable for inclusion, breaks the text of that quote down into a pullquote, and then ensures that the pullquote is included within the search results contained in the user interface 116. The user interface 116 may be a web browser, but could also be some other utility.

The system 100 is centered around consumer reviews, although the techniques described herein may be used with reviews from other sources (e.g. critics, experts, agencies, bloggers, etc.). Content providers are moving in the direction of user-provided content, such as reviews and opinions of various goods and services. User-provided content such as reviews may be directed not only to just consumer products, but also destinations such as hotels and restaurants. Additionally, user-provided content can include reviews of cinema, entertainment, and cultural items or events, and even include information on publicly traded companies. Thus, the system 100 is suitable for content providers that have consumer reviews present as content that is native therein, that was freely provided by users, is not paid advertisement, and is thus objective and user-generated.

### Ratings System

According to one embodiment, system 100 selects consumer reviews to include in search results based, at least in part, on a comparison between ratings given in the reviews and an aggregate rating across all reviews for the same subject matter. For example, in one embodiment, for a consumer review to be considered for use within a pullquote, the numerical star-rating accompanying that review must be mathematically near to an aggregate rating of all numerical star-ratings for that product, service, location, or other subject of consumer reviews. In such an embodiment, consumer reviews that do not also include a numerical star-rating will not be eligible for use as a pullquote.

The system 100 includes an averager 106 for generating the aggregate rating that is compared against individual review ratings in the review selection process. According to one embodiment, averager 106 can be configured to use any of mean, median, or mode to arrive at the most suitable numeric approximation of which numeric star-rating should be used.

According to one embodiment, the averager 106 also utilizes a ratings system for the consumer reviews themselves. The reviews are rated and point-scored using (for example) responses to the inquiry “did this rating help you?”. According to one embodiment, system 100 only uses a consumer review as pullquote if some (adjustable) threshold of users have said “yes” to this inquiry for the consumer review.

In one embodiment, a freshness factor is also taken into account by averager 106 when selecting consumer reviews to use as pullquotes. For example, in one embodiment, consumer reviews that are older than a certain threshold age are removed and not used by either the quote extractor 108 or averager 106. The age at which consumer reviews cease to be eligible for being used as a pullquote may vary based, for example, on how highly the consumer review was rated by other consumers.

### User Interface

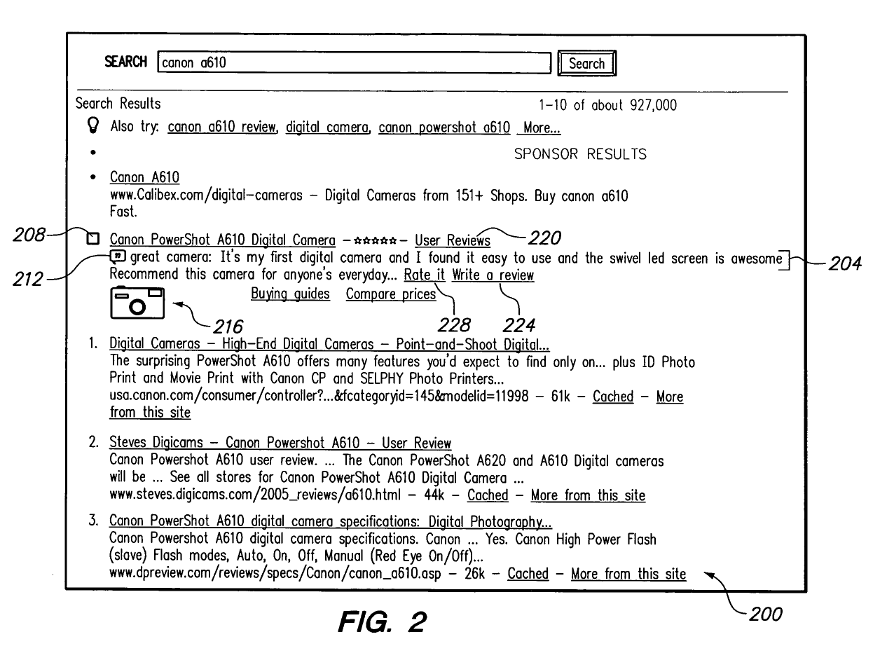

FIG. 2 shows an example user interface 116 with search results produced by the system 100. In FIG. 2 and the explanations associated therewith, it will be understood that the user performed a search on the Canon A610 digital camera. From FIG. 2, it is apparent that the search results are shown in numerical order, and that a total of four results are shown. However, the first search result is different than those following for several reasons, and will be referred to hereinafter as a shortcut. First, the shortcut illustrated in FIG. 2 has a content provider logo 208 in the location normally used for numeric ordering. The provider logo 208 draws attention to the fact that the system 100 enables the content provider to do more for a user than merely provide generic search results.

Next, the shortcut also contains a pullquote 204, which is symbolized by the “quote” symbol 212, as well as a digital image 216 ostensibly of the searched item submitted by a consumer. The first result also contains a means for users to rate the product 228, to write their own review 224, to reach other user reviews 220, and a pictorial image of that product's aggregate numeric star-rating 232 according to the pool of consumers who participated in rating a product. The shortcut can also include access to buying guides links and price comparison links that where possible are related to that specific product which was the subject of the search.

The pullquote 204, along with the user rating stars ratings 232, draws more attention to the shortcut by immediately presenting what many users are seeking without requiring the user to go through additional steps. That is, the search results page itself displays text from the review, so the user may read the quoted portion of the review without even having to leave the search results page.

In an embodiment that uses reviews written by consumers, the reviews tend to be authentic. For example, in one embodiment, the reviews are generated by users of a user review feature provided by the same party the controls the search engine, not by a product manufacturer such as Canon. Thus, the reviews are not likely to be influenced by commercial interests outside the control of the content provider employing the system 100. An embodiment in which the user reviews are obtained from consumers by the same party that is providing the search engine is also advantageous because the consumer reviews are not reproduced from elsewhere and are thus not subject to copyright restrictions or contractual or commercial obligations.

At least because of its authenticity and convenient location, the pullquote 104 increases the “click through rate” of the search results. Increasing the click through rate of the search results, in turn, may have commercial significance for the content provider employing the system 100.

Transforming Passive Readers into Active Reviewers

FIG. 2 provides merely one example of how a shortcut, generated using the techniques described herein, may be presented. For example, in other embodiments, a shortcut can have more or less lines than what is shown, and also can have more or less features than what is shown. The number of lines per shortcut may affect how much revenue can be gained by content provider using the system 100.

In one embodiment, each shortcut includes “rate it” 228 and “write a review” 224 links. It is beneficial to include “rate it” and “write a review” links because the system 100 seeks to aggregate and coordinate the rating, writing, and reading of reviews so that all can be done in one easy starting point. Thus, the system 100 strives to turn mere readers of reviews into writers of reviews.

Additionally, search engines may be where users first begin to research a product, but users may visit many areas. For example, users may also perform a search with a content provider's resources to solve some kind of special problem with a new product, or get information about a product feature that the user does not understand. After solving the problem, such a user may be inclined to then write a review.

### Anticipating and Resolving User Errors

If, during a search, reviews for a specific product are not found, or are not contained within the archiving mechanism 104, then the system may re-route the user to similar products, or perhaps post a warning “did you mean <suggestion>?” in case of spelling errors or word usage anomalies. The system 100 may also provide spelling assistance. One example of spelling assistance would be to provide results related to “Canon” even though “cannon” was typed.

Additionally, if the archiving mechanism 104 doesn't have any review for “Canon A610”, but does have a review for “Canon digital camera”, then the system 100 may provide a shortcut to “Canon digital camera” reviews within the ranked search results. However, in such a case, the system 100 may not provide a pullquote.

### Use of Images Within the Shortcut

In one embodiment, the shortcut includes both the pullquote 204 and a digital image 216. It is helpful to include digital images is because users like to see images with consumer reviews. The quote extractor 108 is involved in the production of a suitable image. For example, writing a review of a restaurant can have a place to upload a digital image of the restaurant. However, the restaurant could contest the picture if the restaurant feels that the digital image is unfair. To address this, the system 100 can include a governing or arbitration mechanism to ensure that the images are accurate, and images can be substituted. Supposing a restaurant contested the image used in a review, it may be possible to remove the offending image and substitute another image.

The system 100 is not limited to the embodiment shown in FIG. 2. For example, the search results could contain several pullquotes 204 and not merely a single pullquote. In one embodiment, the formatting engine 112 includes a mechanism to ensure that, to the extent possible, the pullquote 204 has useful data. Depending on whether space permits, the shortcut can have some type of raised letters or emphasis, potentially a border, and may be displayed in a bigger font.

### Multiple Matches

It is possible for many rated items to match a search engine user's search criteria. Under these circumstances, the search results may include a single shortcut for the most relevant item, a single shortcut with pullquotes for multiple items, or multiple shortcuts, each of which may be for one or more items. In one embodiment that presents a single pullquote, the pullquote selected for display is for the lowest price matching item. In another embodiment, the specific consumer item associated with the pullquote 204 is selected based on “relevance”, and may not actually be the lowest-priced matching item.

In embodiments that pullquotes for multiple items, the pullquotes may be presented in a ranking that is based on a variety of factors, one of which may be the price of the item that is reviewed in the pullquote. Other ranking factors may used in addition to, or instead of, price. For example, there may be reasons why a product ranked high in search results is not in fact the least expensive product that satisfies the search criteria. Negative consumer reviews of either a product or the merchant selling a product could impact rankings.

When the display ranking does not correspond to price ranking, the search results page may alert a user to such price discrepancies through some type of visual warning mechanism. In one embodiment, the search results include a link “rank by expense” to enable a user to re-order the search results. A shortcut and pullquote 204 could still be included within the re-ranked results.

As shown in FIG. 2, the site DPreview.com is a professional review site. Professional review sites are valuable and may appear in the ordinary search results of the system 100. In one embodiment, content from professional review sites are not used within pullquotes.

### Using Search Terms as a Steppingstone

A user might be searching on a specific product sometimes only as a starting point. To that end, the Canon A610 product might be just a trigger or steppingstone in a search about digital cameras in general. That user may be wondering “what are the other digital cameras I should be thinking about”. To that end, an alternate embodiment exists in which the search results are formatted to list “top 10 products in this class”. Within this alternate embodiment, a user can search by product category rather than by specific product. For example, some users may search for “laptop” or “digital camera”, without a specific product title.

### Modified User Interface to Avoid “Pogo-Stick” Problem

A further alternative embodiment exists in which clicking User Reviews 220 (FIG. 2) would show some number of reviews in a dropdown (frame), but where the user does not leave the original page The dropdown (frame) could include shortcuts containing one or more pullquotes, buying guides, reviews, and “compare price” options, perhaps in a tabs format. The dropdown (frame) would only partially cover the original page, so that a portion of the original page would remain unobscured. Using this feature, a user could intelligently continue their search and explore various options but without leaving the original page.

For example, a user might enter a music group and get a pullquote, plus an image of the latest album, and perhaps even an excerpt of a song by the music group, yet all without leaving the original search page. Allowing the user to see this information without leaving the page avoids requiring a user to “pogo-stick” between websites, which means that a browser gives up information related to a previous site, goes to a new site, and starts displaying information from that new site with a clean slate. For users that want to travel between sites, it is necessary to clutter a browser's history, force a user to use the “back” or alt-LeftArrow feature of a browser, and consume significant amounts of memory. The dropdown (frame) feature might require Web 2.0, but the system 100 would still function even without Web 2.0. In such a case, the dropdown (frame) may have less utility in a non Web 2.0 environment.

The pullquote 204 is selected for inclusion based partly on the rating conforming to an aggregate numeric rating, plus the “did this review help you” inquiry. Users can also be offered a “see all merchants” link. Although not shown, users can also be offered a “compare prices” link.

The user interface 116 may also provide a way for users to purchase a product, either directly or through a third party merchant. A rating system for third party merchants is also contemplated within the system 100. Under specific circumstances, a highly rated merchant might get included within a pullquote 204, thus forming a type of a “pullmerchant”.

The system 100 enhances not just click through rate, but also quality of those clickthroughs, because the users that read the pullquotes are more enlightened. The conversion rate, or rate of users that stay interested, continue seeking information, and eventually buy something is higher once those users then arrive at a third party merchant link.

### Hardware Overview

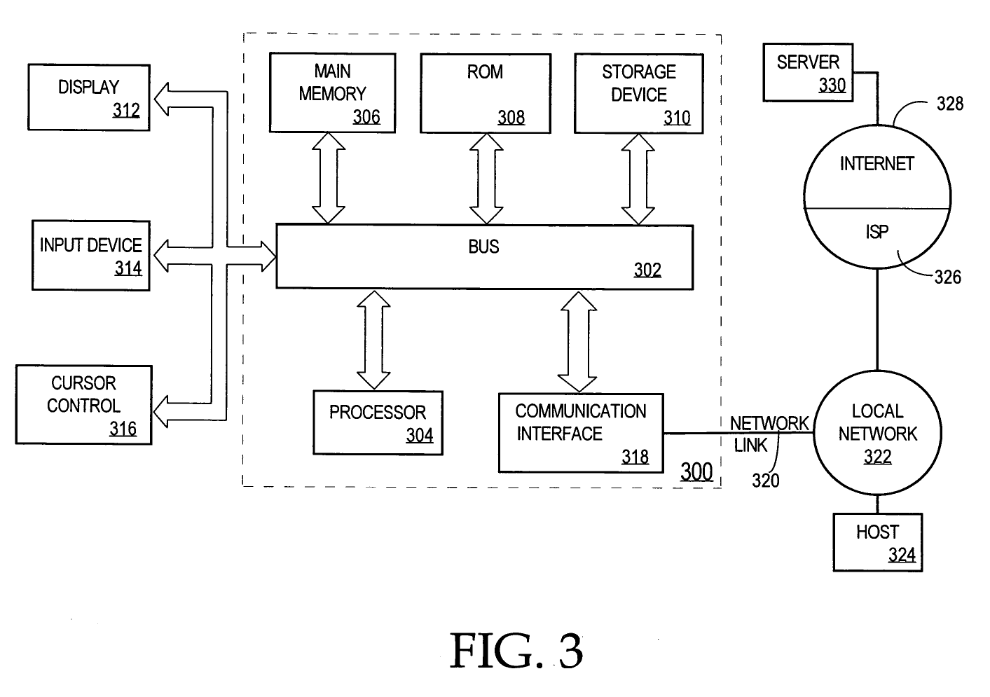

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 300, various computer-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a computer.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
accepting a search query, from a user;
determining that said search query is directed to particular subject matter;
based on a plurality of numerical ratings for said particular subject matter, determining a aggregate rating for said particular subject matter;
based on the aggregate rating, selecting, from a plurality of reviews for said particular subject matter, a representative review;
including at least a portion of said representative review in a collection of search results for said search query; and
making the collection of search results accessible to the user.

2. The method of claim 1 wherein:
the step of accepting a search query is performed by a search engine that is controlled by a particular party; and
the plurality of reviews are consumer reviews obtained through a consumer review mechanism provided by said particular party.

3. The method of claim 1 wherein:
the method further comprises ranking the collection of search results, and
the step of making the collection of search results accessible includes presenting the search results in an order that is based on said ranking.

4. The method of claim 1, wherein the aggregate rating is an average rating of said plurality of reviews.

5. The method of claim 1, wherein the aggregate rating is a mode rating of said plurality of reviews.

6. The method of claim 1, wherein the aggregate rating is a median rating of said plurality of reviews.

7. The method of claim 1, wherein the step of selecting includes determining which consumer review, of the plurality of reviews, has a rating that is closest to said aggregate rating.

8. The method of claim 1, wherein:
the method includes populating an archiving mechanism with a plurality of consumer reviews, wherein each review has a numerical rating; and
the step of selecting a representative review includes searching said archiving mechanism for reviews based on search criteria specified in said search query.

9. The method of claim 1, wherein selecting the representative view is perform based, in part, on helpfulness rankings associated with the plurality of reviews.

10. The method of claim 9, wherein the step of selecting the representative view based on helpfulness rankings includes:
determining whether the helpfulness ranking of a particular review exceeds a threshold; and
the step of selecting the review includes selecting the particular review in response to determining that the helpfulness ranking of the particular review exceeds a particular threshold.

11. The method of claim 1, further comprising:
identifying reviews earlier than a predetermined time threshold; and
not using reviews that are earlier than the predetermined time threshold as representative reviews.

12. The method of claim 1, wherein the step of making the collection of search results accessible further comprises including, within the collection of search results, a link which, when selected, presents an interface for receiving a rating for said subject matter.

13. The method of claim 1, wherein the step of making the collection of search results accessible further comprises including, within the collection of search results, a link which, when selected, presents an interface for writing a review for said subject matter.

14. The method of claim 3, wherein the representative review is displayed first among a ranked listing of search results.

15. The method of claim 15, wherein the representative review is displayed using any of raised letters, a border, or a font exceeding the size of a font of the other search results.

16. The method of claim 3, wherein:
the representative review is one of a plurality of representative reviews present in said ranked collection of search results; and
the step of ranking the collection of search results includes ranking the representative reviews based, at least in part, on prices associated with subject matter reviewed in said representative reviews.

17. The method of claim 3, wherein:
the representative review is one of a plurality of representative reviews present in said ranked collection of search results; and
the step of ranking the collection of search results includes ranking the representative reviews based, at least in part, helpfulness rankings associated with said representative reviews.

18. The method of claim 1, wherein the step of making the collection of ranked search results accessible includes a digital image of the entity described by the representative review.

19. A computer-implemented method, comprising:
receiving a search query at a search engine;
determining a set of documents that match said query;
based on first selection criteria, determining a set of one or more consumer reviews that are directed to subject matter related to said query;
based on second selection criteria that is different from said first selection criteria, selecting a set of one or more representative consumer reviews from said set of one or more consumer reviews;
including, in a collection of search results for said search query, (a) listings for documents from said set of documents, and (b) listings for representative consumer reviews from said set of one or more representative consumer reviews;
wherein the listing for each representative consumer review includes at least a portion of text from said representative consumer review; and
making the collection of search results accessible to the user.
